(19) United States
(12) Patent Application Publication
(10) Pub. No.: US 2005/0113229 A1
(43) Pub. Date: May 26, 2005

(54) Universal mandrel

(75) Inventor: Ronald Ralph Cairo, Greer, SC (US)

Correspondence Address: NIXON & VANDERHYE P.C./G.E., 1100 N. GLEBE RD., SUITE 800, ARLINGTON, VA, 22201, US

(73) Assignee: General Electric Company, Schenectady, NY (US)

(21) Appl. No.: 10/720,172

(22) Filed: Nov. 25, 2003

(51) Int. Cl. B25F 5/02; F16C 13/00

(52) U.S. Cl. 492/45; 492/49

(57) ABSTRACT

A universal mandrel includes a core mandrel having an outside diameter, and at least one adapter sleeve having an inside diameter sized to engage the core mandrel outside diameter. An interlocking mechanism is secured between the core mandrel and the at least one adapter sleeve. The interlocking mechanism serves to prevent the adapter sleeve from rotating relative to the core mandrel. The design allows a prototype composite ring to be filament wound even though the final ring diameter would be subject to change.

### BACKGROUND OF THE INVENTION

The present invention relates to a universal mandrel and, more particularly, to a universal mandrel accommodating a large range of component diameters for fabricating components with fiber-reinforced composite materials.

Mandrels are used in the composites industry to fabricate bodies of revolution such as rings and cases using filament winding, tow or tape placement. A typical mandrel for a composite ring is shown schematically in FIG. 1. Many turbine engine components are built around bodies of revolution with the diameter set as a function of machine performance requirements. The current approach to manufacturing is to build a “specific use” mandrel of either metal or eutectic salt. These mandrels, however, cannot accommodate a large change in diameter.

A typical 35-inch outside diameter mandrel would be able to accommodate a composite part inside diameter change of ½-inch (34.5-inch inside diameter). This approach, with the associated first cost of raw material and fabrication, in addition to lead-time, adds cost to implementing a composite component across a broad product line. A mandrel concept with the ability to accommodate a large range of component diameters can greatly reduce the fabrication cost and time to market of composite components.

Eutectic salt is typically used to build low-cost mandrels of different diameters, with tooled steel being the material of choice for robust production tooling. The tooled steel can be procured oversize in diameter and machined to a smaller diameter should the need arise for a component diameter change. There is, however, a limit on the amount of material removable because filament winding requires tension to be applied to the filaments to hold them in position. This filament tension imparts a radially inward pressure on the cylindrical mandrel, which, if made too thin, will buckle or implode.

It would be desirable to develop a mandrel design that would allow a prototype composite ring to be filament wound even though the final ring diameter would be subject to change.

### BRIEF DESCRIPTION OF THE INVENTION

In an exemplary embodiment of the invention, a universal mandrel includes a core mandrel having an outside diameter, and at least one adapter sleeve having an inside diameter sized to engage the core mandrel outside diameter. An interlocking mechanism is secured between the core mandrel and the at least one adapter sleeve. The interlocking mechanism serves to prevent the adapter sleeve from rotating relative to the core mandrel.

In another exemplary embodiment of the invention, a universal mandrel includes a core mandrel having an outside diameter, and at least one adapter sleeve having an inside diameter sized to engage the core mandrel outside diameter. An interlocking mechanism is secured between the core mandrel and the at least one adapter sleeve. The interlocking mechanism serves to prevent the adapter sleeve from rotating relative to the core mandrel. In addition, a thermal expansion rate of the adapter sleeve is lower than that of the core mandrel.

### BRIEF DESCRIPTION OF THE DRAWINGS

FIG. 1 illustrates a conventional single-use mandrel for winding fiber-reinforced composite parts;

FIG. 2 is an assembly drawing of the universal mandrel of the present invention;

FIG. 3 is an end view of an assembled universal mandrel; and

FIG. 4 illustrates an application of a universal mandrel for fabricating reinforcing rings of carbon/epoxy in a generator construction; and

FIG. 5 depicts another embodiment of the invention in which an adapter ring of the universal mandrel is designed to be an integral part of the finished component to provide either buffered thermo-mechanical properties for the reinforcing ring or serve as a load diffusion path to provide more uniform loading to the composite ring for enhanced structural performance or life.

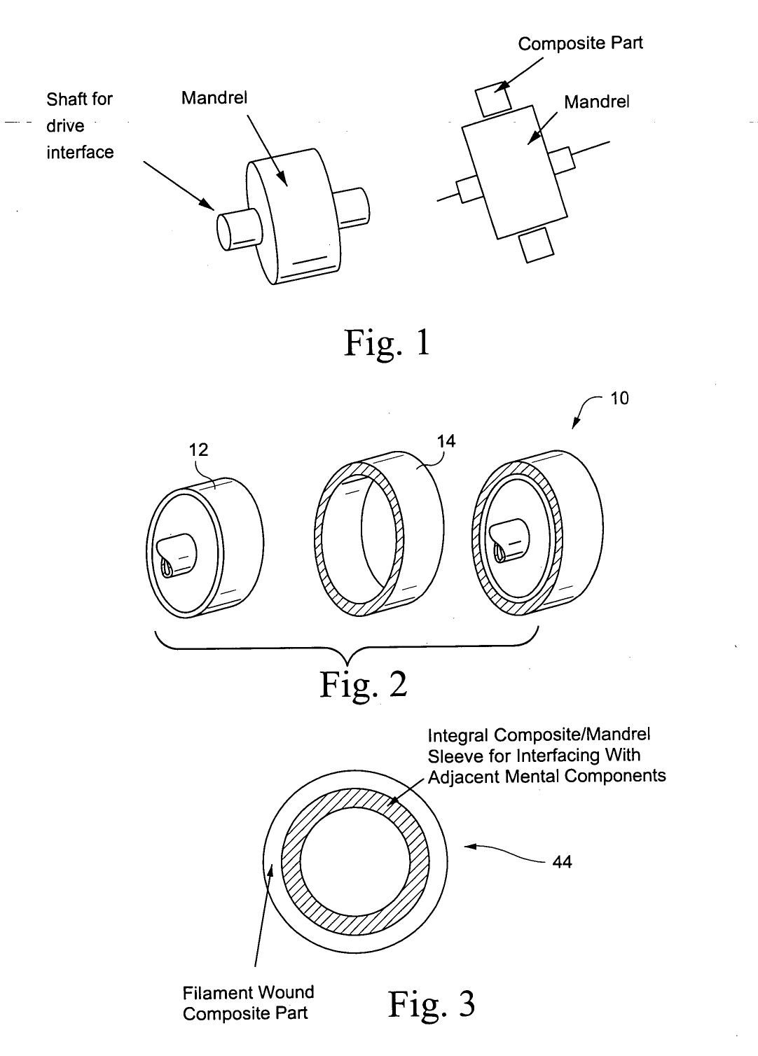

### DETAILED DESCRIPTION OF THE INVENTION

FIG. 2 is an assembly drawing of the universal mandrel 10 of the invention. The universal mandrel 10 includes a core mandrel 12 formed generally of a conventional construction, and an adapter sleeve 14. The inside diameter of the adapter sleeve 14 is sized to fit over the core mandrel 12 outside diameter in a snug fit. An interlocking mechanism 16 is secured between the core mandrel 12 and the adapter sleeve 14 to prevent the adapter sleeve 14 from rotating relative to the core mandrel 12.

With continued reference to FIG. 2, in one embodiment, the interlocking mechanism includes a lug 18 formed on the inside diameter of the adapter sleeve 14, which is shaped to fit into a correspondingly sized slot formed in the outside diameter of the core mandrel 12. Alternatively, the lug 18 may be formed on the outside diameter of the core mandrel 12 with a corresponding slot formed on the inside diameter of the adapter sleeve 14.

In another arrangement, the interlocking mechanism 16 may include a flange 20 formed on one edge of the adapter sleeve 14. The flange 20 includes at least one opening 22 therein, wherein a connector 24, such as a pin or bolt, is fit in the opening 22 to secure the flange 20 to an axial face of the core mandrel 12.

In order to accommodate varying size part diameters, the universal mandrel may include a plurality of adapter sleeves 14 of varying exterior dimensions. This concept enables the rapid and cost-efficient implementation of design revisions and designs for different sized turbine machinery.

Preferably, the adapter sleeve 14 is constructed of tooled steel. In use, a composite ring is assembled by filament winding on the universal mandrel, then curing the material at temperature on the mandrel. For materials requiring higher curing temperatures, other suitable materials may be used for the adapter sleeve 14.

The adapter sleeves 14 is additionally constructed for dual use. That is, the thermal expansion of a composite ring being constructed on the mandrel is generally much lower than a metal, and the composite ring is consequently generally interfaced with a higher expansion rate metal component (rather than another composite component). The inclusion of the adapter sleeve 14 as part of the wound composite can facilitate an interface connection with another metallic component and/or provide an intermediate expansion rate medium to “buffer” a large thermal mismatch between the composite component and the interfaced metallic component. See, for example, FIG. 3.

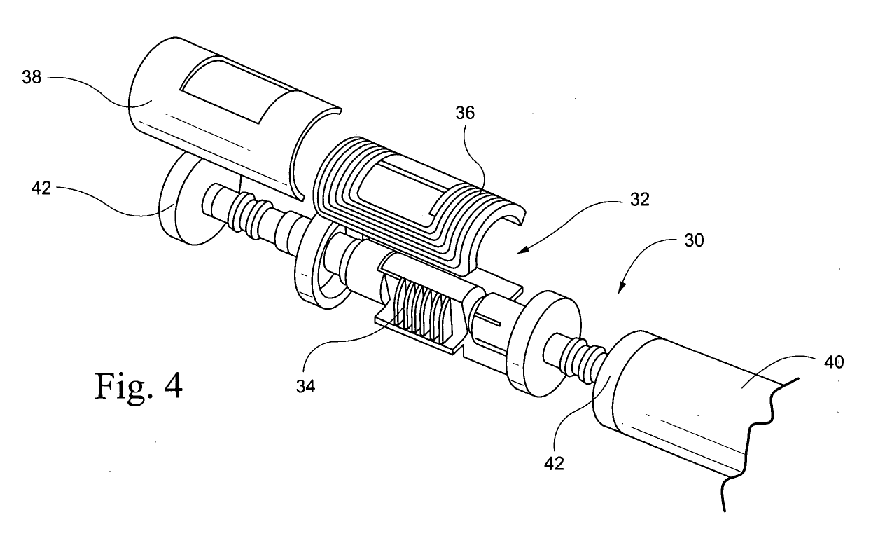

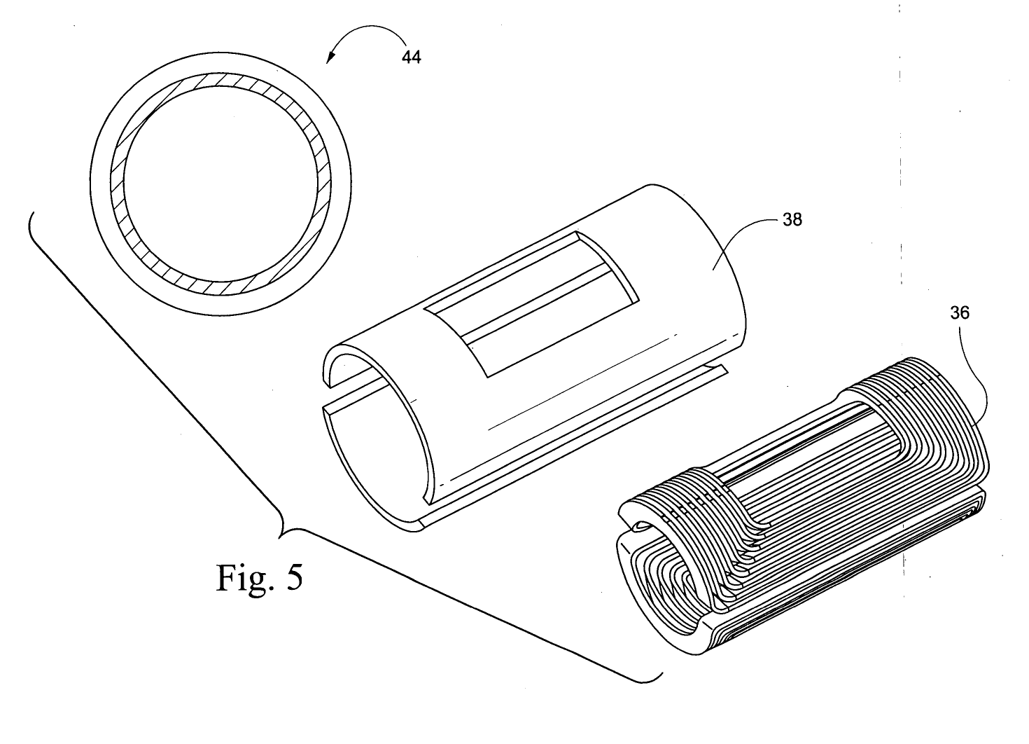

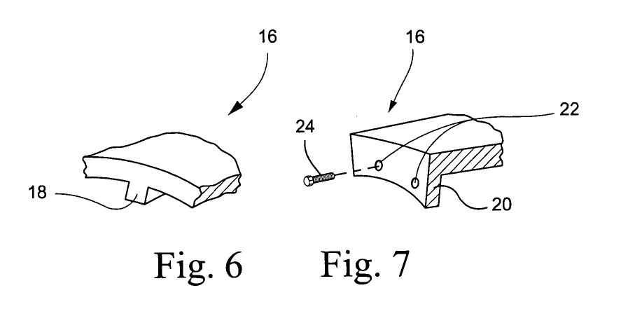

An application of this concept to a generator is shown in FIGS. 4 and 5. FIG. 4 shows a break-away view of a generator assembly comprising a rotor shaft 30 with integral pole piece 32, copper coil support frame 34, copper coils 36, split shield (case) 38, composite end support cylinders 40, and composite reinforcing rings 42. The composite reinforcing rings 42 are the only body of revolution structural pieces holding the interior components (copper coil support frame 34, copper coils 36, split shield 38) in position during rotation. The high specific strength and stiffness (strength/density, stiffness/density) of the composite rings 42 help make this design feasible. The composite rings 42 have to not only restrain the centrifugal loading imparted by the interior components but also their own inertial loads. The composite rings 42 are spaced uniformly along the length of the rotor for dynamic stability of the generator system.

FIG. 5 is a schematic representation of another embodiment of the invention that utilizes an adapter from the universal mandrel as an integral part of the finished composite reinforcing ring to create a hybrid ring 44. The adapter can be specifically tailored to provide either an intermediate expansion rate zone to mitigate thermo-mechanical incompatibility between the composite ring and the split case or to provide a load diffusion path for more uniform loading along the inner diameter of the composite ring. FIG. 5 shows sequence of assembly: copper coils 36, then split case 38, then the hybrid reinforcing rings 44.

With the universal mandrel of the invention, a prototype composite ring can be filament wound even though the final ring diameter is subject to change. By accommodating a large range of component diameters, fabrication costs and time to market of composite components can be greatly reduced.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A universal mandrel comprising:
a core mandrel having an outside diameter;
at least one adapter sleeve having an inside diameter sized to engage the core mandrel outside diameter; and
an interlocking mechanism secured between the core mandrel and the at least one adapter sleeve, the interlocking mechanism preventing the at least one adapter sleeve from rotating relative to the core mandrel.

2. A universal mandrel according to claim 1, wherein the interlocking mechanism comprises a lug formed on either the outside diameter of the core mandrel or the inside diameter of the adapter sleeve, and a slot formed in the other of the outside diameter of the core mandrel or the inside diameter of the adapter sleeve, the lug engaging the slot when the adapter sleeve is fitted to the core mandrel.

3. A universal mandrel according to claim 2, wherein the lug is formed on the inside diameter of the adapter sleeve, and wherein the slot is formed in the outside diameter of the core mandrel.

4. A universal mandrel according to claim 1, wherein the interlocking mechanism comprises a flange formed on one edge of the adapter sleeve, the flange having an opening therein, and a connector sized to fit in the opening and secure the flange to an axial face of the core mandrel.

5. A universal mandrel according to claim 4, wherein the connector comprises a pin or a bolt.

6. A universal mandrel according to claim 1, wherein the adapter sleeve is structurally configured to serve as an interface connection with another metallic component.

7. A universal mandrel according to claim 1, wherein the adapter sleeve is structurally configured to serve as an intermediate expansion rate medium to buffer a thermal mismatch between a composite component and an interfaced metallic component.

8. A universal mandrel according to claim 1, comprising a plurality of adapter sleeves of varying exterior dimensions.

9. A universal mandrel according to claim 1, wherein the adapter sleeve is constructed of tool steel.

10. A universal mandrel comprising:
a core mandrel having an outside diameter;
at least one adapter sleeve having an inside diameter sized to engage the core mandrel outside diameter; and
an interlocking mechanism secured between the core mandrel and the at least one adapter sleeve, the interlocking mechanism preventing the at least one adapter sleeve from rotating relative to the core mandrel,
wherein a thermal expansion rate of the adapter sleeve is lower than that of the core mandrel.

11. A universal mandrel according to claim 10, wherein the interlocking mechanism comprises a lug formed on either the outside diameter of the core mandrel or the inside diameter of the adapter sleeve, and a slot formed in the other of the outside diameter of the core mandrel or the inside diameter of the adapter sleeve, the lug engaging the slot when the adapter sleeve is fitted to the core mandrel.

12. A universal mandrel according to claim 11, wherein the lug is formed on the inside diameter of the adapter sleeve, and wherein the slot is formed in the outside diameter of the core mandrel.

13. A universal mandrel according to claim 10, wherein the interlocking mechanism comprises a flange formed on one edge of the adapter sleeve, the flange having an opening therein, and a connector sized to fit in the opening and secure the flange to an axial face of the core mandrel.

14. A universal mandrel according to claim 13, wherein the connector comprises a pin or a bolt.

15. A universal mandrel according to claim 10, comprising a plurality of adapter sleeves of varying exterior dimensions.

16. A universal mandrel according to claim 10, wherein the adapter sleeve is constructed of tool steel.
